(19) United States
(12) Patent Application Publication
(10) Pub. No.: US 2025/0225386 A1
(43) Pub. Date: Jul. 10, 2025

(54) REFLEXIVE MODEL GRADIENT-BASED RULE LEARNING

(71) Applicant: Raytheon Company, Tewksbury, MA (US)

(72) Inventors: Joshua A. Binkley, Richardson, TX (US); Philip A. Sallee, South Riding, VA (US)

(21) Appl. No.: 18/405,609

(22) Filed: Jan. 5, 2024

(51) Int. Cl. G06N 3/08; G06N 5/04

(52) U.S. Cl. CPC G06N 3/08; G06N 5/04

(57) ABSTRACT

Systems, devices, methods, and computer-readable media for reflexive model generation and inference. A method includes receiving probabilistic rules of a reflexive model that correlate evidence with existence of an event of interest, training, based on ground truth examples of evidence and respective labels indicating whether the event of interest is/was/will be present or not, a neural network (NN) to encode the probabilistic rules and learn respective probabilities for the probabilistic rules, and providing, by the NN and responsive to new evidence, an output indicating a likelihood the event of interest exists.

### TECHNICAL FIELD

Embodiments regard explainable artificial intelligence (AI).

### BACKGROUND

There is a need for explainable AI. Explainable AI includes technologies that can summarize the structure of complex functions, such as neural networks (NNs) in human understandable terms. It is desired for these technologies to seamlessly integrate with NNs to provide end-to-end learnable explanations of global structure, and to be able to explain individual predictions. Both of these explanation types can be consumable in a unified language that is immediately understandable and actionable by a human operator for both understanding which features are most impactful to decisions globally, and how particular values of those different features when used together produce different inference outcomes at the instance level. There is also a related problem of how to incorporate subjective domain knowledge into AI systems—humans benefit from understanding how the AI operates and having an ability to adjust the AI based on their domain knowledge and intentions in a straightforward manner, such as by providing the AI with rules to incorporate in the inference process.

### BRIEF DESCRIPTION OF DRAWINGS

FIG. 1 illustrates, by way of example, a diagram of an embodiment of a system for improved event inference (e.g., indicating presence of an event or object of interest).

FIG. 2 illustrates, by way of example, a diagram of an embodiment of a system that includes a model, generated by the system 100, in operation.

FIG. 3 illustrates, by way of example, a conceptual diagram of a system in accord with embodiments.

FIG. 4 illustrates, by way of example, a diagram of a system in accord with embodiments.

FIG. 5 illustrates, by way of example, a flow diagram of an embodiment of a technique for generating an explainable AI.

FIG. 6 illustrates, by way of example, a diagram of an embodiment of an explanation layer of an NN that operates to determine whether an object or event is present based on provided evidence.

FIGS. 7, 8, 9, and 10 illustrate, by way of example, respective graphs of a variety of results for training and operation of an instance of a system that implements a learned reflexive model.

FIG. 11 illustrates a conceptual diagram of an embodiment of an NN to implement the technique.

FIG. 12 illustrates, by way of example, a diagram of an embodiment of a method for learned reflexive model inference and explanation.

FIG. 13 is a block diagram of an example of an environment including a system for neural network (NN) training.

FIG. 14 illustrates, by way of example, a block diagram of an embodiment of a machine in the example form of a computer system within which instructions, for causing the machine to perform any one or more of the methods or techniques discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

A goal of explainable artificial intelligence (AI) is to summarize an AI decision process in human-understandable terms. Explaining an AI decision helps establish trust and accountability for using AI in operational decision making. Explainable AI, ideally, can summarize complex, continuous and non-linear functions in terms of human-understandable rules and probabilities.

Embodiments can incorporate subjective domain knowledge, such as by adding human knowledge to AI models. This knowledge is often subjective, based on generalities, and subject to uncertainty. Embodiments can use data-driven training processes to incorporate human domain knowledge in terms of global rule-based explanations and refine and validate these explanations to account for uncertainty and exceptions.

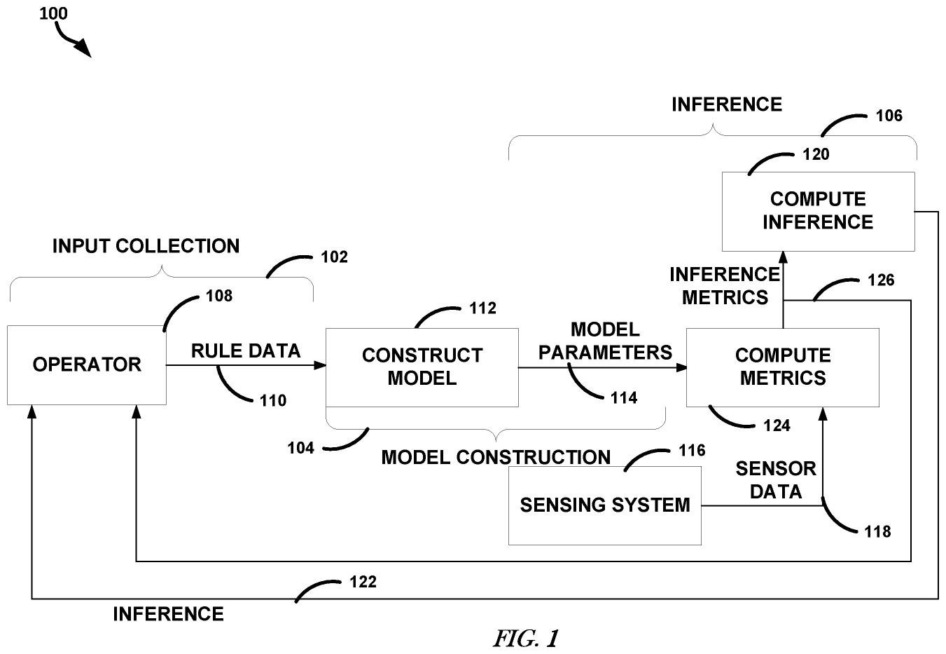

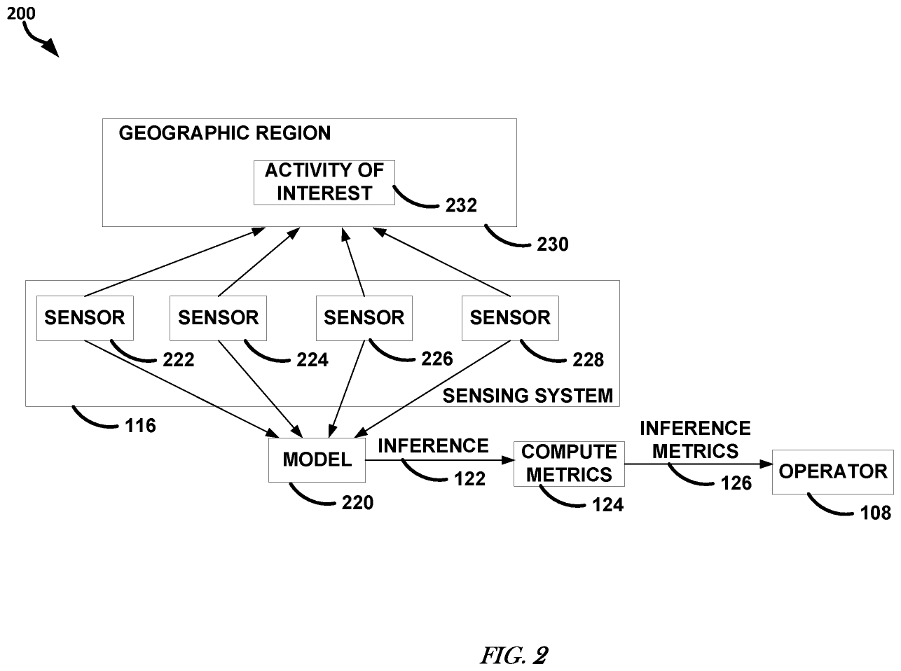

Embodiments learn a set of weighted logical rules which globally explain a set of data in terms of its outputs. The form of these weighted rules follows a reflexive model that employs modal logic. More details regarding a reflexive model are provided in FIGS. 1 and 2, among others. The ideal function is provided as:

$${φ}^{*} = ( a + b ) ( 1 - c ) [ - a ( ε + τ - 2 ) + ε - 1 ] + τ - ε$$

$$H ( x ) = \{ \begin{matrix}1 , & x > 0 \\ 0 , & x \leq 0\end{matrix}$$

$$a = H ( τ - ε )$$

$$b = H ( ε - τ )$$

$$c = H ( ( 1 - ε ) τ ( 1 - τ ) ε )$$

where the inputs ε and τ are described in [39]. The approximation is provided as Equations:

$${φ}^{∼} = ( a + b ) ( 1 - c ) [ - a ( ε + τ - 2 ) + ε - 1 ] + τ - ε$$

$$a = f ( τ - ε , t )$$

$$b = f ( ε - τ , t )$$

$$c = f ( ( 1 - ε ) τ ( 1 - τ ) ε , t )$$

Where ƒ(x, t) is a differentiable function which approximate the Heaviside step function such as

$$\frac{tanh ( xt ) + 1}{2} ,$$

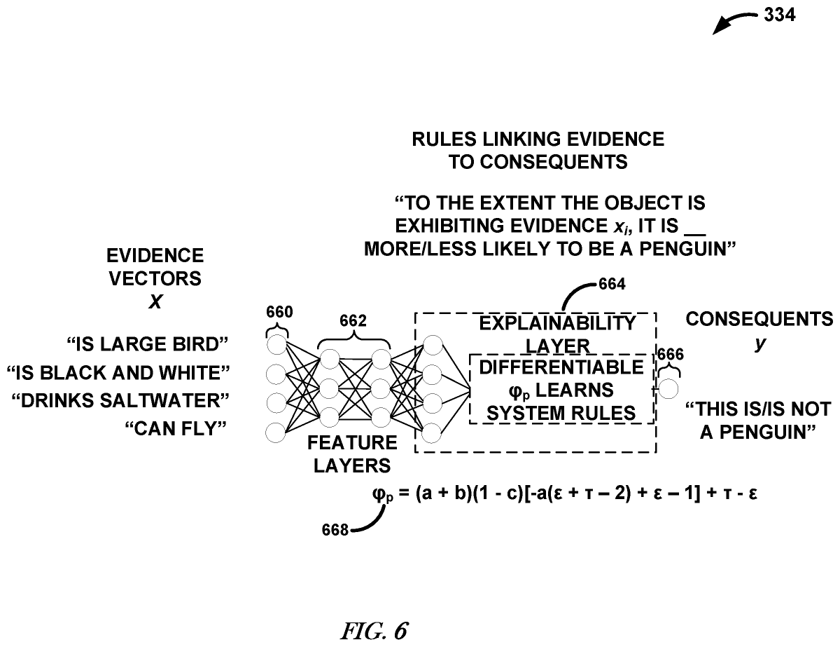

and t is an possible additional parameter of that function subject to a scheduling function as described later in this disclosure.
At a high level, embodiments are capable of producing quantified logical statements that estimate not only the type of impact of each feature (positive and negative predictors), but also the probabilistic extent of the impact (how much of a positive predictor, how much of a negative predictor) each piece of evidence has on a consequent. Embodiments accomplish this through the introduction of a neural module which encodes a differentiable approximation (φ^{˜}) of the reflexive function (φ*). This module takes as input 1) a set of learnable parameters which jointly encode the type (positive or negative) and extent (magnitude) of a weighted logical rule as described elsewhere in this document, 2) the evidence vector (which may be one or both of layers 660, 662 (see FIG. 6) depending on the embodiment) for a particular example, and 3) during training, one or more parameters for an annealing function and produces inference outcome which can be compared to a truth label. That comparison is made through a loss function, and the resultant gradient updates the inputs to the neural module so that over the course of training, those inputs are closer to capturing the correct explanations. Concurrently, the module itself uses an annealing process over the course of training to allow the differentiable approximation φ^{˜} mentioned above to approach the ideal φ* for reflexive models—only the ideal function can perform exact inference on a feature vector given a rule set. As such, over the course of training, the annealing process adjusts the inferences produced using φ^{˜} such that they can increasingly tend towards the same values as would be produced by exact inference of the non-differentiable function φ*. In other words, the annealing process allows the network to initially explore a very large extent of the solution space and gradually converge toward (ideally) the optimal solution as directed by the gradient. The outputs of training this system can include a global explanation; the outputs when using this system at inference time include a predicted value for the consequent itself, as well as a local explanation of why the consequent was provided as an output. The predictor encoding is also amenable to human influence; operators are able to incorporate subjective domain knowledge in the form of rules that can be directly ingested by the AI to adjust the reasoning process and better reflect operator intent—this is accomplished by directly setting the values of the learned rule parameters 6XX to align with the desired semantics—for example, to incorporate knowledge that, say, the 4^{th} evidence value is a negative predictor with magnitude 0.75 of the target variable, the 4^{th} learned rule parameter 6XX should be directly set to −0.75.

Current research in neurosymbolic AI is focused in the direction of encoding human knowledge rather than decoding networks, and similarly, current research in explainable AI is focused on first order logic (FOL), fuzzy logic, and probabilistic/Bayesian approaches. Embodiments are the only known process to use modal logic to circumvent limitations of these approaches. In addition to this novelty, the implementation of embodiments including how the objective function is “relaxed” to φ^{˜} and how an annealing function is used to make the relaxed objective function approach the objective function φ* in the limit allow traditional neural network (NN) gradient training to be used for explainable AI.

Machine reasoning systems are built with assumptions about a target environment. The assumptions are often a poor reflection of reality. Examples of such assumptions include prior probabilities for probabilistic reasoning systems and training data for artificial intelligence (AI) systems. That the assumptions are a poor reflection of reality in many cases weakens the reliability and trust of the systems. The weakness of the assumptions further pose risk to those tasked with taking action based on system inference.

Previously, rule-based expert systems tried to provide inference without prior probabilities; but, these rule-based expert systems were brittle. They were brittle because these systems were based on basic predicate or FOL which can't handle certain kinds of rule sets or situations in the field with incomplete or contradictory evidence. These prior systems also rarely incorporated multi-valued quantifications over rules, e.g. probabilistic quantifiers. Computational complexity tended to be exponential as the modeling within these systems was essentially that of a satisfiability (SAT)-solver.

Embodiments are not looking to see whether conditions can satisfy arbitrary predicates under a complex system of statements. Instead, embodiments are more closely related to current AI systems and probabilistic systems in that embodiments ascertain a quantified judgement on a single object or event of interest. This judgment is independent of statistical properties about the domain of discourse measured from data in the system, or the various conditions under which different logical statements are satisfied. Embodiments also do not require the use of priors, which in existing art can be unreliable as previously stated, and whose unreliability can only be mitigated within particular types of probabilistic models, and then only by adding more training data, which may be unreliable as well (in unseen environments, training data is unavailable and proxy synthetic data is used for model training—this data may be entirely synthetic, or it may be based on a very small number of examples that do not sufficiently represent the environment).

Embodiments regard systems in which operators (considered an example of a “subject matter expert” (SME)) can directly specify beliefs about indicators of events of interest. The operator need not also specify how likely those indicators or activities are. Even without the likelihood that the indicators occur being specified in advance, embodiment can provide reasoning capabilities.

Embodiments regard monitoring, reacting to, or otherwise acting in light of events of interest. An event of interest may be a complex phenomenon with a plurality of evidence for whether the phenomenon has taken place, or it may be the occurrence of a similarly complex entity whose existence can be determined from a plurality of evidence. An event of interest can include a disaster and resulting repercussions, such as building stability, hunger relief, shelter access, or the like. The event of interest may be the presence of a physical object, for example a specific vehicle or an instance of a class of vehicles, e.g., fishing vessels, boats and/or other air, land, maritime vehicles. In the case of a complex entity such as a fishing vessel, the plurality of evidence may include sensor data establishing architectural features of the boats, or even behavioral indicators of fishing activity such as patterns of trajectory and location. Embodiments can fuse data about multiple indicators of events of interest, such as from multiple intelligence sources, across time to produce a quantified assessment of whether the event has taken place. The event can be any device, person, occurrence, or object of interest to the operator. The pieces of evidence that are used in the decision may be probabilistic, and prior probabilities that the event has taken place may not be available and is not required for embodiments to operate.

Embodiments provide an automated system for leveraging knowledge about how strongly different evidence that may indicate the event of interest affect the confidence that the event has in fact taken place without needing to specify priors on the event or its indicators in unseen environments, particularly in operator areas of interest wherein determinations regarding events of interest are consequential.

Embodiments estimate a probability that an event has taken place given the evidence seen by the system. Embodiments leverage a quantified set of operator rules that are interpreted as strict conditionals on a common consequent. This common consequent is a logical variable representing the event of interest. The quantification on operator rules are probabilistic, and those rules involve antecedents which are the evidence provided to the system. The antecedents can also be probabilistic. Embodiments process those inputs and produce metrics including the probability of various inference outcomes for the event of interest At a high level, embodiments accomplish the inference by first capturing operator knowledge as a set of modal logic statements, specifically strict conditionals with axiom T as a rule of inference (e.g., p(□(evidence->event) (read as “probability that the evidence necessarily (in an epistemic or actual knowledge sense) suggests that the event is true”), jointly modeling the probabilities of evidence and rules as encoding a set of worlds subject to a type-2 probability distribution, and computing a set of metrics which produce a single unified value representing the most likely truth value for the event of interest, and the certainty associated with it. Unlike a probability value, this value at its midpoint does not represent a 50% probability, but instead represents complete uncertainty—in other words, the midpoint of our metric encodes a reasoning outcome that the true chance of an event occurring may be anything at all (25%, 99%, and so on).

There are at least three aspects of embodiment, which, to the best of the knowledge of the inventors are new and are non-obvious: (1) Framing a probabilistic problem in terms of strict conditionals, (2) Construction of a set of worlds (in the sense of modal logic) as a representation of a set of probabilities on those conditionals; (3) Mechanisms for inference under axiom T in light of (1), (2), or a combination thereof. There is no prior art that explicitly shows or leverages the link between valid inference under axiom T (reflexive models) and conditional probability. Embodiments make explicit use of that link for reasoning about events of interest from evidence to produce metrics for decision making. Embodiments solve problems of prior solutions including an inability to fuse multiple pieces of positive and negative evidence through the use of a conservative modal logic. The axioms employed are not controversial (e.g., S5 or even S4 are not employed). Embodiments are able to entirely restrict the rules of inference leveraged by the system to those contained in T.

Embodiments are not limited to just defense and tactical applications. Embodiments are applicable to any system with uncertain and incomplete knowledge regarding priors wherein indicators of events of interest can be represented and quantified in the form of strict conditional beliefs with associated confidence. Embodiments are applicable to any system in which the predictive strength of an indicator for an event can be quantified. Decision making tools of several varieties fit this description. Some notional examples include (1) bot/troll identification in social networks (e.g., p(□(mechanistic posting intervals->bot))=0.5 . . . ), (2) deep fake identification (e.g., p(□(frame artifacts->fake))=0.1 . . . ), (3) medical testing (e.g., p(□(test defect A->invalid result))=0.2), (4) stock market analysis (e.g., p(□(midterms end in 15 days->positive returns in 30 days))=0.8), among many others.

FIG. 1 illustrates, by way of example, a diagram of an embodiment of a system 100 for improved event inference (e.g., indicating presence of an event or object of interest). The system 100 can operate without prior probabilities. The system 100 as illustrated operates in three phases, input collection phase 102, model construction phase 104, and inference phase 106.

Input collection phase 102 includes receiving, retrieving, or generating rule data 110 based on operator 108 input. The operator 108 is the person or group of persons responsible for managing assets and personnel in a specified geographic region. The operator 108 defines the rule data 110 that is used to for the model construction phase 104 (model construction operation 112). The rule data 110 focuses on the empirical knowledge retained by the operator 108. This is in contrast to a prior probability or using theory or another model to predict what happens in the geographic region.

The input collection phase 102 can include quantifying positive and negative evidence (X) of an event of interest (y). The event of interest is sometimes called a “target” or “target variable” (this is common language in AI), and hence the presence or truth of the target variable as calculated by the inference discussed herein is representative of the presence or truth of the event of interest—the terms “event of interest”, “target”, “target variable” may be used interchangeably for the purposes of discourse. The operator 108 can provide information like, “when evidence, x, is present, the event of interest, y seems to occur with probability p(y|x)”. This sort of information is called a positive indicator since the presence of the evidence increases the likelihood that the event of interest has occurred or is going to occur. The operator 108 can provide information like “when evidence, x, is present, the event of interest, y seems to not occur with probability p(−y|x)”. This sort of information is called a negative indicator since the presence of the evidence decreases the likelihood that the event of interest has occurred or is going to occur. The rule data 110 can thus be a set of positive indicator evidence and a set of negative indicator evidence. Questions posed to the operator 108 in gathering the rule data 110 can include:
Is there evidence that, when realized, makes you think that the event of interest will occur? (e.g., Table 1 variables x,m,n)
If so, what is the evidence and what is the likelihood that the event of interest does occur if the evidence is gathered? (e.g., Table 1 variables a,b,c)
Is there evidence that, when realized, makes you think that the event of interest will not occur? (e.g., Table 1 variables d,e,f)
If so, what is the evidence and what is the likelihood that the event of interest does occur if the evidence is gathered? (e.g., Table 1 variables o,q,r)

In mathematical form, the gathered evidence can take the form in Table 1.

TABLE 1
mathematical representation of the rule data 110.

| Negative Indicators | Positive Indicators |
|---|---|
| p(□(o → ¬y)) = d | p(□(x → y)) = a |
| p(□(q → ¬y)) = e | p(□(m → y)) = b |
| . . . | . . . |
| p(□(r → ¬y)) = f | p(□(n → y)) = c |

The model construction phase 104 converts the natural language rules provided by the operator 108 into model parameters 114. The model parameters 114 can be first specified using more widespread probability notation and then converted to modal notation as shown in Table 1, however, no explicit notation is required for processing; we will discuss later and show in pseudocode how the probabilities of rules and evidence are sufficient to fully specify the computational model; the modal representation in Tables 1 and 2 serve as an aid to understanding the model parameterization.

The model construction phase 104 can include three operations. The operator 108 selects a subset of the system variables which they believe to be correlated to the activity of interest (see FIG. 2). This set is referred to as the set of evidence variables.

For each entry in the set of evidence variables, the user defines a confidence value and a sign (+/−1). The sign, if positive, reflects the belief that the variable is a positive predictor of the target variable. If negative, it reflects the belief that the variable is a negative predictor of the target variable. The confidence value ranges from 0 to 1, where 0 encodes no confidence in the belief, and 1 encodes complete confidence in the belief. The confidence values and signs may also be provided by statistical means such as correlation measurements, artificial intelligence methods, and so on. In some embodiments, confidence value and sign may be jointly encoded; e.g. a negatively signed variable with confidence 1 may simply be encoded as −1. We treat them as separate in this disclosure for simplicity.

Table 2 shows how statements from the operator 108 are encoded into probability notation during model construction phase 104.

TABLE 2
conversion of Operator statements to model constructs.

| Operator Rule | Encoding |
|---|---|
| “If I see x, I think y has probability q” | p(□(x → y)) = q |
| “If I see x, I think y is not there with | p(□(x → ¬y)) = q |
| probability q” | |
| “If I see x, I think y has probability q, | p(□((x&¬a) → y)) = q |
| unless I see a” | |
| “If I see x and b, I think y is not there | p(□((x&b) → ¬y)) = q |
| with probability q” | |

The statements provided by the operator 108 can be aggregated as quantified strict conditionals. The inference phase 106 can use the strict conditionals to perform probabilistic reasoning. The probabilistic reasoning is a type 2 probabilistic reasoning in which inference is made on the event of interest over a set of possible worlds under which both rules and evidence are true or false according to the provided probability (rule probabilities from the operator; evidence probabilities from the connected system).

Rather than assuming the existence of reliable prior probabilities, assuming various statistical forms that a distribution satisfies, assuming that there is a sufficient amount of representative training data, and so on, embodiments model the rules from the Operator 108 as strict conditionals. The models operate under the assumption that strict implication adequately represents intent of the Operator 108. The approach of embodiments requires no training data, no input/output examples, or the like. Instead, the rule data 110 provided by the operation 108 defines the model parameters 114 and thus defines a model that is used to compute an inference 122.

The probabilities determined from the operator 108 statements are encoded as probabilistic modal logic statements. An example conversion is provided:

“I believe that x predicts y with w confidence”a→_{convert} p(□(x→y)=a Equation 1

In Equation 1, x is evidence, y is an event of interest, and a is a quantification of the belief that x predicts y. The system will later assign a probability to whether or not x is true which will be used for inference about y.

Rules, represented by the rule data 110 and sometimes called the model parameters 114, are constructed differently based on whether the operator 108 provides assertions like ‘the indicator is/is not present’ vs ‘we did/did not see the indicator’. The rules and antecedents, when used to construct a set of worlds for probabilistic reasoning are an application of a type-2 probability system. The conditional interpretation of if-then rules in type-1 probability systems is very different from the type-2 paradigm. The type-2 probabilities that can be computed under the modal logic construction described herein using strict conditionals are not possible in a type-1 probability system, as type-1 systems cannot combine logical and probabilistic reasoning. Further, the probabilities computed herein are not possible using a type-2 probability system without the use of modal logic and the strict conditional (using only the material conditional) In fact, it has been said, that the if-then statement approach possible in type-1 paradigms is “so fundamentally wrong that its maladies cannot be rectified simply by allowing exceptions in the form of shaded truth values [i.e. attaching uncertainty values to the statements]”—Probabilistic Reasoning in Intelligent Systems: Networks of Plausible Inference p. 24.

The inference phase 106 includes receiving sensor data 118 from a sensing system 116. The inference phase 106 further includes computing an inference 122 based on the sensor data 118 and the model parameters 114. Computing the inference 122 takes the model parameters 114 from the operator 108 provided rule data 110 (in type-2 probability form, in other words, a probability stated over a universe of possible worlds). Computing the inference 122 can use the sensor data 118 from sensing system 116, to instantiate probabilities of antecedents (representing evidence) to generate an inference 122. The inference 122 is used in a compute metrics operation 124 resulting in inference metrics 126. The inference metrics 126 are human understandable semantics that encode uncertainty for a truth value of an event of interest.

A computing the inference operation 120, to generate the inference 122, can be performed using the following equations.

$$1 - {\prod }_{< {r}^{t} , {x}_{{r}^{t}} > ∈ v} 1 - p ( {r}^{t} ) p ( {x}_{{r}^{t}} ) = p ( {R}_{\hat{w}} ⊢ y )$$

$$1 - {\prod }_{< {r}^{f} , {x}_{{r}^{f}} > ∈ v} 1 - p ( {r}^{f} ) p ( {x}_{{r}^{f}} ) = p ( {R}_{\hat{w}} ⊢ ¬ y )$$

$${\prod }_{< {r}^{t} , {x}_{{r}^{t}} > ∈ v} 1 - p ( {r}^{t} ) p ( {x}_{{r}^{t}} ) = p ( {R}_{\hat{w}} y )$$

$${\prod }_{< {r}^{f} , {x}_{{r}^{f}} > ∈ v} 1 - p ( {r}^{f} ) p ( {x}_{{r}^{f}} ) = p ( {R}_{\hat{w}} ¬ y )$$

$$ε = {\prod }_{< {r}^{t} , {x}_{{r}^{t}} > ∈ v} 1 - p ( {r}^{t} ) p ( {x}_{{r}^{t}} )$$

$$τ = {\prod }_{< {r}^{f} , {x}_{{r}^{f}} > ∈ v} 1 - p ( {r}^{f} ) p ( {x}_{{r}^{f}} )$$

Table 3 details different calculations that can be performed to provide information about the system being modeled.

TABLE 3
different inference metrics that provide information
about the system being modeled

| Probability of | y | ¬y | Formula |
|---|---|---|---|
| Inconsistency | ├ | ├ | (1 − ε)(1 − τ) |
| Certain truth | ├ | [symbol] | (1 − ε)τ |
| Certain falsity | [symbol] | ├ | (1 − τ)ε |
| Ambiguity | [symbol] | [symbol] | τε |
| | | | Σ = 1 |

The operation 120 can be performed under the assumption that the rules, represented by the rule data 110 and provided by the operator 108, are always consistent. That is, the assumption is strict that there is no world in which both evidence for truth and falsity of y exists as in the following Equation:

$${φ}_{strict} = \frac{CT}{CT + A} - \frac{CF}{CF + A} = τ - ε$$

Where CT is certain truth, CF is certain falsity, and A is ambiguity.

The operation 120 can be performed under the assumption that the world is consistent, although sensors may be wrong or rules may be off by some small factor. That is, the assumption is permissive such that certain rules with certain antecedents will in all possible worlds yield an inference of ‘true’ for the event of interest as in the following Equations:

$${φ}_{permissive} = ( a + b ) ( 1 - c ) [ - a ( ε + τ - 2 ) + ε - 1 ] + τ - ε$$

$$H ( x ) = \{ \begin{matrix}1 , & x > 0 \\ 0 , & x \leq 0\end{matrix}$$

$$a = H ( τ - ε )$$

$$b = H ( ε - τ )$$

$$c = H ( ( 1 - ε ) τ ( 1 - τ ) ε )$$

A Heaviside step function can be used in φₚₑᵣₘᵢₛₛᵢᵥₑ i.e. φ* because the atoms themselves are discrete—there is ample precedent in traditional probability of this function, and especially its derivative (Dirac delta function). The system essentially takes input statements, computes a probability distribution over 4 outcomes on y from sensor data, and computes signed measures with the appropriate semantics. Note that all of these formulas can be represented as linear equations, (e.g., p(R_{ŵ}F├y)=1.0−Determinant(IdentityMatrix[{|R_{ŵ}|,|R_{ŵ}|}]*[1.0−[{p(r^{t})p(aᵣ_{^{t}})| [symbol] r^{t}, aᵣ_{^{t}} [symbol] ∈U}]]).

An example justification for the probability of being able to validly infer that an event of interest, y, is true as follows: Across the set of worlds, let p(r^{t}) be the probability that a rule is true and p(aᵣ_{^{t}}) be the probability that the antecedent for rule r is true. Only rules with true consequents (positive evidence) can be used to infer y, and then only when their antecedents [the sensor data 118] are true. It only takes one such (rule, antecedent pair) to validly infer y. Therefore, the probability of validly inferring y is 1—the probability of being in a world where there is no such rule, antecedent pair:

$$p ( {R}_{\hat{w}} ⊢ y ) = 1 - {\prod }_{〈 {r}^{t} , {a}_{{r}^{t}} 〉 ∈ U} 1 - p ( {r}^{t} ) p ( {a}_{{r}^{t}} )$$

The inference 122 can be a value in a range of real numbers or similar. The range can be [−1, 1] where −1 means that “y is false” is certain to be a valid inference, 0 means complete ambiguity, and 1 means that “y is true” is certain to be a valid inference. The inference 122 is the output of the φ function. Inference metrics include the probabilities in Table 3. The inference metrics 126 are explanatory metrics that shed light on how the inference 122 was made and why. The range of φ is between −1 and 1 in the general case. Under certain rule configurations, it may be constrained to [−1, 0] such as when only negative indicators are provided, or to [0,1], such as when only positive indicators are provided.

The operation 124 can include determining the values in Table 3. The result of the operation 124 is inference metrics 126. The inference metrics 126 can be provided to the operator 108, so that the operator 108 can make a decision.

The inference metric 126 is very understandable: −1.0 equates to a Boolean false with 100% certainty, also to a probability of zero of the event given the rules. Moving toward zero is still a Boolean false, but with increasing uncertainty about the inference. Zero is complete uncertainty. From zero to one is moving from complete uncertainty through ‘leaning towards true’ to complete confidence that y can be inferred from the rules and system data.

The inference metric 126 is explainable: The operator 108 is in complete control of the rule set. All inferences can be understood in terms of those rules, and the probability that in aggregate, the event of interest can be inferred to be true or false given the system data. The inference 122 includes not only complete traceability back to operator rules (the rule data 110) and system inputs (sensor data 118), but can also be understood in terms of semantically straight-forward metrics provided by [0032] for ambiguity, inconsistency, and consistency for truth values of the consequent.

Embodiments provide a model from which the inference 122 can be computed. The model is comprised of strict conditionals with a common consequent as a target variable for machine inference. That is, embodiments provide a modal logic based machine inference model constructed from rule data. That model partially specifies a set of worlds which are fully specified at inference time given system data from the connected system. The fully specified set of worlds is sufficient for the inference described herein. Embodiments operate using type 2 probability structures that operate over a modal universe with defined processes for inference on an event of interest (using axiom T in conjunction with probabilistically instantiated rule and evidence logic sentences). Embodiments can include a determination of several metrics that can be computed from the model given data from a sensing system.

A Type 2 probability system” denotes a system of probabilistic reasoning over a set of states. This is opposed to a Type 1 probability system that denote a probability over a domain of objects. In embodiments, each “world” is a possible state comprised of multiple domain objects (event of interest and all evidence) and different sets of rules according to the probabilities provided by the operator 108 for rule confidence. By constraining the set of states to 1) containing only conditionals whose consequent is the event of interest, and their antecedents and 2) using the rule and evidence probabilities to determine the truth values of the statements in 1 for each world, embodiments have constructed a set such that it supports type-2 probabilistic reasoning from which we can derive inference metrics on the event of interest.

“Axiom T” is an inference rule in modal logic which states that if something is necessary in a world (box), then it is True; (e.g., if it is necessary from a set of conditions that an object, event and/or phenomenon, e.g., a penguin, a vehicle, a person etc., exists, then it does exist).

FIG. 2 illustrates, by way of example, a diagram of an embodiment of a system 200 that includes a model, generated by the system 100, in operation. The system 200 as illustrated includes a model 220 (defined by the model parameters 114) that receives input from the sensing system 116 (in FIG. 2 the sensing system 116 includes sensors 222, 224, 226, 228). The model 220 determines the inference 122. The inference 122 is used as input to the operation 124. The operation 124 determines the inference metrics 126 that are provided to the operator 108. The operator 108 makes a decision regarding an activity of interest 232 in a geographic region 230.

The sensing system 116 produces sensor data 118 that is used as evidence for input to the model defined by the model parameters 114. Example sensors that can be included in the sensing system 116 include ambient condition sensors (e.g., pressure, temperature, wind speed, wind direction, relative humidity, evaporation, ultraviolet or solar radiation, precipitation, chemical, leaf wetness, negative ion, soil ph., soil npk, noise, or the like), image sensors (e.g., an imaging device, such as range detection and ranging (RADAR), light detection and ranging (LIDAR), sound detection and ranging (SONAR), optical, electrooptical, super spectral, infrared, or the like), object recognition system, tracking system, or the like. While there are four sensors 222, 224, 226, 228 illustrated in FIG. 2, more or fewer sensors can be used.

The system 200 is sometimes called a connected system. A connected system is one which provides measurements on a subset of the variables in a domain of discourse (the geographic region 230 in the example of FIG. 2). In general, the connected system is a computing system which processes measurements from sensors or aggregates and processes measurements from other computing systems. The model 220 can operate directly on the connected system that directly ingests measurements from the sensing system 116 or on another computing system which ingests measurements from the connected system.

As used herein a “Domain of discourse” is: A set of probabilistic atomic variables including system variables the connected system provides measurements for via the sensing system 116, and a single specified target variable for which the connected system does not provide measurements.

A “Strict Conditional” is a logical statement of the form □(a→b) where □ is the modal logic quantifier for necessity, a is the antecedent (sometimes called evidence) of the conditional, and b is the event of interest (→ denotes implication). The inference over worlds in the model 220 computes probabilities of different inference 122 outcomes across a set of worlds, where the model 220 inference system includes the standard modal logic axiom T which states □a→a, or roughly ‘if a is necessary, then a is the case’, and wherein for some worlds, a strict conditional will be true, and in others, it will be false. In worlds where the strict conditional is false (i.e. ¬□(a→b)), and the consequent is true (satisfied given other antecedent/conditional pairs), the box operator precludes contradiction. This contrasts with the negation of a material conditional wherein the statements ¬(a→b) and b give a contradiction since ¬(a→b) implies ¬b. In other words, the box operator, in cases where the conditional is false, prevents the model 220 from assuming anything about b so that antecedents tied to true conditionals can produce truth values for the event of interest in a consistent manner without contradiction.

The set of evidence variables and associated signs and confidence values are stored and jointly constitute the model 220. Each element in model 220 is referred to as a rule. The interpretation of the model 220 is a set of confidence-weighted strict conditionals, each of which relates an evidence variable to a particular truth value of the activity of interest 232.

Example rule setup and model interpretation:
Setup
Operator belief number 12: “80% of the time, if there is smoke, there is fire”
Target variable: “there is fire”
System data: There is smoke with 100% probability
Desired output: a confidence of probability measurement on the statement “there is fire”
Reflexive Model:
Model interpretation: p(□(s→ƒ))=0.8
Rule: [symbol] 12, positive, 0.8 [symbol]
Output: A 0.8 confidence for the statement ‘there is fire’
Note: In some embodiments, rule arrays may be accessed by index, removing a need for the first element in the tuple above. Positive and negative rules may also be stored in their own arrays, removing the need for a sign. Positive and negative rules are treated as separate in this disclosure for simplicity.

Operating on the rule using a Bayesian approach, which is contrasted with embodiments:

In this situation one is looking to estimate p(f) given p(f|s). Say p(f|s)=0.8 is a known posterior probability, and the marginal p(s)=1.0 is received from the system, one must assume that p(s|f)*p(f) also equals 0.8 by Bayes Rule. To determine the prior, p(f), one would be forced to give the likelihood p(s|f) which may not be provided by the connected system (for this example, note that hydrogen fires do not produce smoke). One may also consider providing a prior on p(f) and updating probabilities based on further information and rules, however this assumes that one has a known history of fires in the environment for sampling from or to form the basis for a user belief—in many cases such history is inaccessible or even non-existent. The output of such an approach is nothing without additional information.

Embodiments do not require the likelihoods or priors that are required for the Bayesian techniques (or other similar techniques). Instead embodiments leverage a type-2 probability system over a set of modal worlds suggested by the model 220 to perform inference. In this case, in 80% of the worlds, the statement □(s→ƒ) is true, and in the other 20%, it is false. As with type-1 probability calculations, one does not need to explicitly store the set of all possible worlds—the probability of the statement represents the set sufficiently for the inference 122.

As with most statistical processes, an assumption encoded in the model 220 is that the rules are applicable to the inference environment.

```
Pseudocode
BuildModel(S) is:
  M = { }
  While input.inProgress:
    r = <>
    r.index = input({s.index for s in S})
    r.p = input(0 to 1 value)
    r.sign = input(positive, negative)
    M = M ∪ {r}
  Return M
Quantify(M, E) is
  Qₚ := { }
Qₙ := { }
  Forr ∈ M:
    e := E[r.index]
    If e.isMeasured:
      If r.sign is positive:
        Qₚ := Qₚ ∪ {{r, e)}
      Else:
        Qₙ := Qₙ ∪ {{r, e)}
  Return Qₚ, Qₙ
Condition(Q) is:
  x := 1
  For q ∈ Q:
    x := x * [1 − q.s.p * q.r.p]
  Return x
CertaintyStrict(ε, τ) is:
  Return τ − ε
Heaviside(x) is:
  If x > 0:
    Return 1
  Else:
    Return 0
CertaintyPermissive(ε, τ) is:
  A = Heaviside(τ − ε)
  B = Heaviside(ε − τ)
  C = Heaviside((1 − ε)τ(1 − τ)ε)
  Return (a + b)(1 − c)[−a(ε + τ − 2) + ε − 1] + τ − ε
Infer(M, E, Strict) is:
  < Qₚ, Qₙ> := Quantify(M, E)
  ε = Condition(Qₚ)
  τ = Condition(Qₙ)
  Inf = <>
  Inf.inconsistancy := (1 − ε)(1 − τ)
  Inf.ctruth := (1 − ε)τ
  Inf.cfalsity := (1 − τ)ε
  Inf.ambiguity := ετ
  If Strict:
    Inf.inference := CertaintyStrict(ε, τ)
  Else:
    Inf.inference := CertaintyPermissive(ε, τ)
  Return Inf
```

### Operational Workflow

BuildModel(S) is called on the system S (a computer system that can operate the model 220). S is assumed to have an indexing structure containing the available evidence capabilities such that, for example, S[index] will return a reference to the capability. The measurement capabilities S[index] are expected to correspond to the system measurements of evidence E[index] and to the rules of M[index](indices are assumed to be aligned for the purposes of this pseudocode but need not be aligned).

As system data is ingested, the function Infer( ) is called on available evidence, E, to provide the inference 122. The function Infer( ) takes three parameters and returns a real-valued inference and explanatory metrics (in some embodiments the explanatory metrics may not be required). The parameters are
a. The model from BuildModel, M
b. Evidence from the connected system, E
c. A Boolean parameter the operator chooses, Strict or Permissive

The output of the Infer( ) function is an infer object containing:

Inference: a [−1, 1] valued real number whose readings are interpreted as follows:
−1 indicates certainty that the available evidence evaluated against the rules suggests that the target variable has a truth value of false
0 indicates that the available evidence evaluated against the rules suggests that the target variable has a completely uncertain truth value
1 indicates certainty that the available evidence evaluated against the rules suggests that the target variable has a truth value of true

When strict mode is indicated by the Boolean parameter (e.g., is set to true), this encodes the assumption that the rules will always produce consistent results against any set of system data. When it is set to false (permissive mode), this encodes the assumption that the world is consistent, i.e. although sensors may be wrong or rule weights may be off by small factor, certain rules with certain antecedents yield certain consequents—this has the effect of clamping the inference values as follows:
−1 when at least one <antecedent, rule> pair takes the value <1,−1>
1 when at least one <antecedent, rule> pair takes the value <1,1>
0 when the first two conditions are both satisfied.

Explanatory Variables: As the model encodes a type-2 probability distribution over worlds, there are certain salient properties of the distribution that explain the value of the certainty measure. It should be noted here that in each world, the evidence variables are probabilistically assigned to either true, or false, yielding several possible situations. For example, a rule with sign 1 for antecedent x with confidence 0.8 and the target variable y encodes that there is an 80 percent chance that a given world will contain the statement □(x→y), i.e. the rule has a truth value of true, and a 20 percent chance that the world will instead contain the statement ¬□(x→y), i.e. the rule has a truth value of false. Similarly, when the system measures an 80 percent probability of antecedent x, this encodes that there is an 80 percent chance that a given world will contain the statement x, and a 20 percent chance that the world will instead contain the statement ¬x. The four explanatory variables (in Table 3) are mutually exclusive with respect to a single world, and always sum to one across the set of worlds; they may be thought of as jointly constituting a probability distribution over the four possible inference outcomes on the target variable over the set of worlds that the rule and antecedent probabilities suggest. The explanatory variables are
Inconsistency: Represents the probability that in any given world, the truth values for rules and antecedents may be used to produce both true and false truth values for the target variable
Certain Truth: Represents the probability that in any given world, the truth values for rules and antecedents yield a truth value of true for the target variable and cannot yield a value of false
Certain Falsity: Represents the probability that in any given world, the truth values for rules and antecedents yield a truth value of false for the target variable and cannot yield a value of true
Ambiguity: Represents the probability that in any given world, the truth values for rules and antecedents do not yield any truth value for the target variable

Examples highlighting some operation of the model:

1. In this example, the activity of interest 232 for inference 122 is the statement ‘is fire’. The operator 108 has encoded the rule data 110 for gas being a positive indicator with 0.5 confidence, water being a negative indicator with 1.0 confidence, smoke being a positive indicator with 0.9 confidence, and flame being a positive indicator with 1.0 confidence. The connected system measures a 1.0 probability of smoke and water, and a 0.0 probability of gas and flame.
Rules: [Rule<gas,0.5,1>, Rule<water,1.0,−1>, Rule<smoke,0.9,1>, Rule<flame,1.0,1>]
System Evidence: {‘gas’: 0.0, ‘smoke’: 1.0, ‘water’: 1.0, ‘flame’: 0.0}
Qp: {Rule<gas,0.5,1>: 0.0, Rule<smoke,0.9,1>: 1.0, Rule<flame,1.0,1>: 0.0}
Qn: {Rule<water,1.0,−1>: 1.0}
eps: 0.1
tau: 0.0
Output (permissive): {‘inference’: −1.0, ‘inconsistancy’: 0.9, ‘certain_truth’: 0.0, ‘certain_falsity’: 0.1, ‘ambiguity’: 0.0}
Output (strict): {‘inference’: −0.1, ‘inconsistancy’: 0.9, ‘certain_truth’: 0.0, ‘certain falsity’: 0.1, ‘ambiguity’: 0.0}
   2. In this example, the activity of interest 232 for the inference 122 is the statement ‘stocks go up’. The operator 108 has encoded the rule data 110 for the recent completion of an election cycle being a positive indicator with 0.8 confidence, and the current day being Monday being a negative indicator with probability 0.25. The connected system measures a 0.0 probability of a recent election cycle completing, and a 1.0 probability of it being a Monday.
Rules: [Rule<presidential_election_completed,0.8,1>, Rule<monday,0.25,−1>]
System Evidence: {‘presidential_election_completed’: 0.0, ‘monday’: 1.0}
Qp: {Rule<presidential_election_completed,0.8,1>: 0.0}
Qn: {Rule<monday,0.25,−1>: 1.0}
eps: 1.0
tau: 0.75
Output (permissive): {‘inference’: −0.25, ‘inconsistancy’: 0.0, ‘certain_truth’: 0.0, ‘certain_falsity’: 0.25, ‘ambiguity’: 0.75}
Output (strict): {‘inference’: −0.25, ‘inconsistancy’: 0.0, ‘certain_truth’: 0.0, ‘certain_falsity’: 0.25, ‘ambiguity’: 0.75}
   3. In this example, the activity of interest 232 for the inference 122 is the statement ‘is a bot’. The operator 108 has encoded the rule data 110 for detected machine posting patterns being a positive indicator with 0.95 confidence, and the account belonging to a verified user being a negative indicator with 0.95 confidence. The connected system reads posts and measures a 0.5 probability of a machine posting pattern, and a 0.0 probability that the account has been verified to belong to a real person.
Rules: [Rule<machine_posting_pattern,0.95,1>, Rule<verified_account,0.95,−1>]
System Evidence: {‘machine_posting_pattern’: 0.5, ‘verified_account’: 0.0}
Qp: {Rule<machine_posting_pattern,0.95,1>: 0.5}
Qn: {Rule<verified_account,0.95,−1>: 0.0}
eps: 0.525
tau: 1.0
Output (permissive): {‘inference’: 0.475, ‘inconsistancy’: 0.0, ‘certain_truth’: 0.475, ‘certain_falsity’: 0.0, ‘ambiguity’: 0.525}
Output (strict): {‘inference’: 0.475, ‘inconsistancy’: 0.0, ‘certain_truth’: 0.475, ‘certain_falsity’: 0.0, ‘ambiguity’: 0.525}
   4. In this example, the activity of interest 232 for the inference 122 is the statement ‘is valid test result’ which may apply to any number of domains (medical testing, software testing, machine testing, and so on). The operator 108 has encoded the rule data 110 for two measurable defects in the test procedure, and two confirmations of the test result. The connected system provides probabilistic measurements from the two confirmation procedures each at 0.5, and the defects at 0.25 and 0.75.
Rules: [Rule<defect_a,0.5,−1>, Rule<confirmation_procedure_a,0.75,1>, Rule<defect_b,0.25,−1>, Rule<confirmation_procedure_b,0.75,1>]
System Evidence: {‘defect_a’: 0.25, ‘confirmation_procedure_a’: 0.5, ‘defect_b’: 0.75, ‘confirmation_procedure_b’: 0.5}
Qp: {Rule<confirmation_procedure_a,0.75,1>: 0.5, Rule<confirmation_procedure_b,0.75,1>: 0.5}
Qn: {Rule<defect_a,0.5,−1>: 0.25, Rule<defect_b,0.25,−1>: 0.75}
eps: 0.390625
tau: 0.7109375
Output (Permissive): {‘inference’: 0.3203125, ‘inconsistancy’: 0.1761474609375, ‘certain_truth’: 0.4332275390625, ‘certain_falsity’: 0.1129150390625, ‘ambiguity’: 0.2777099609375}
Output (Strict): {‘inference’: 0.3203125, ‘inconsistancy’: 0.1761474609375, ‘certain_truth’: 0.4332275390625, ‘certain_falsity’: 0.1129150390625, ‘ambiguity’: 0.2777099609375}

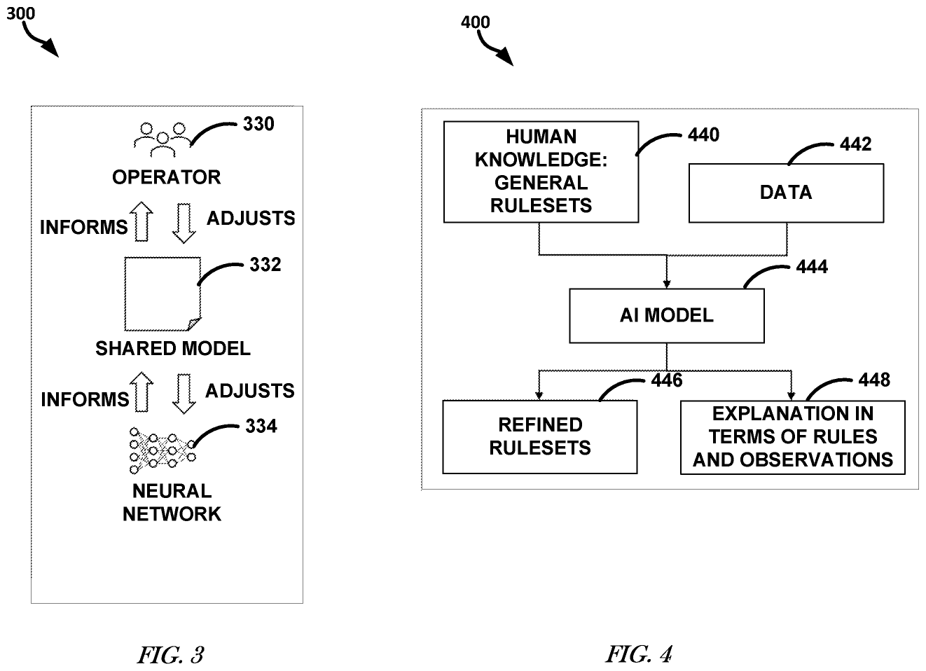

FIG. 3 illustrates, by way of example, a conceptual diagram of a method 300 in accord with embodiments. In embodiments, an operator 330 defines rules that, in aggregate, form a shared model 332. The rules are statements of the form “to the extent the object is exhibiting evidence xᵢ, it is ______% more/less likely to be of classy”. The rules regard evidence that, when present, support that the object is of the class and also regard evidence that, when present, supports that the object is not of the class. As additional rules are understood, the operator 330 can add the newly understood rules. When a neural network (NN) 334 indicates that the rule is not determinative of whether the object is or is not of the class, the rule can be removed from the shared model 332. The NN 334 operates to determine (i) a likelihood that indicates how determinative presence of the evidence is of the consequent and (ii) whether the presence of the evidence is positive (indicating that the object is of the class) or negative (indicating that the object is not of the class). The NN 334 provides the consequent and corresponding reasoning for the classification decision (consequent). The reasoning can include the rules that were triggered based on the evidence and what is and/or is not present in the evidence. For example, the reasoning can include determinative evidence, such as, “the object has a propeller and is therefore not a penguin” or non-determinative evidence, such as, “the object is a large bird and is black and white, therefore it is more likely than not that the object is a penguin”.

FIG. 4 illustrates, by way of example, a diagram of a technique 400 in accord with embodiments. The technique 400 includes human knowledge, in the form of general rulesets 440 provided by an operator 330. The technique 400 further includes data 442, sometimes called evidence, that informs an AI model 444 (e.g., the NN 334) the likelihood that the evidence indicates the consequent and whether the evidence is indicative of the consequent or counter-indicative of the consequent. The AI model 444 completes the rule set to include the likelihood and whether the evidence is indicative or counter-indicative in a refined ruleset 446. The AI model 444 also provides an explanation 448 in terms of rules and observations (sometimes called “evidence”).

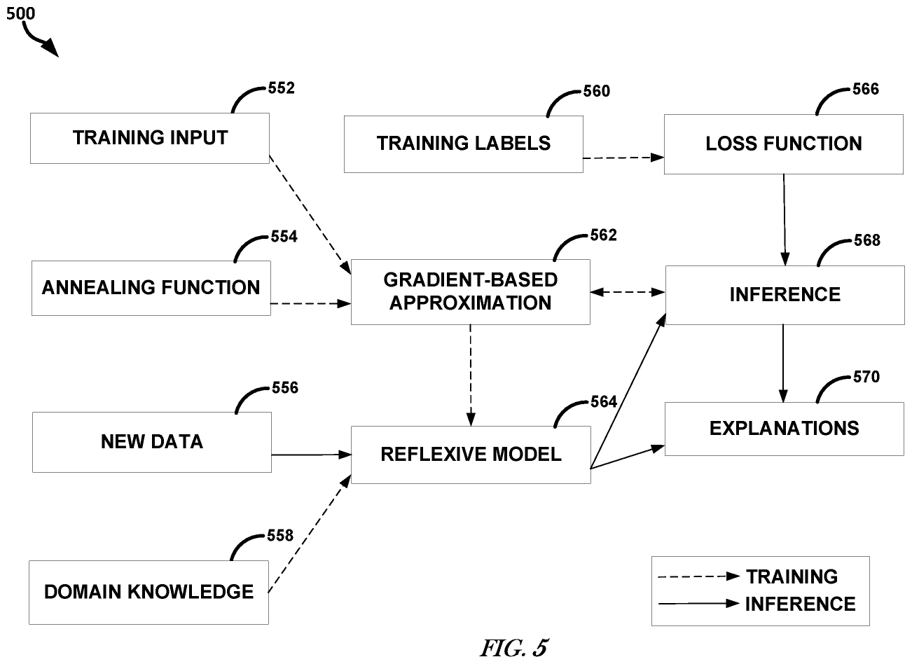

FIG. 5 illustrates, by way of example, a flow diagram of an embodiment of a technique 500 for generating an explainable AI. The explainable AI performs inference 568 and is trained using a loss function 566 and a gradient based approximation 562 of likelihoods. Training input 552 is provided in the form of evidence and corresponding classifications. The evidence can include images, intelligence data (e.g., open source intelligence (OSINT), geospatial intelligence (GEOINT), cyber intelligence, signals intelligence (SIGINT), human intelligence (HUMINT), measurement and signature intelligence (MASINT), financial intelligence (FININT), technical intelligence (TECHINT), or the like. The classification is a desired output and can be provided manually, or by a reliable classifier but is otherwise known to be truthful.

An annealing function 554 can be used on a reflexive model 564 function. The annealing function 554 approximates the reflexive model function in a way that makes the reflexive model function differentiable. Using the annealing function, a relaxed version of the reflexive model function approaches the actual reflexive model function as the number of epochs of training increases. The annealing function 554 is used in a process called simulated annealing. Simulated annealing is a probabilistic technique for approximating a global optimum of a given function. In embodiments, the global optimum is known as the reflexive model function. Thus, the annealing approximates the reflexive model function in a manner that is differentiable (has a derivative) so that gradient-based approximation 562 can be used to determine optimal parameters of the NN that operates to determine the parameters of the reflexive model 564.

Training labels 560 (ground truth output) are provided to a loss function 566. The loss function 566 can be one of a variety of loss functions including mean-squared error, among many others. The loss function 566 can quantify a difference between the training labels 560 and the inference 568. The loss determined by the loss function 566 can be used by the gradient-based approximation to adjust parameters of the NN. The parameters of one or more layers of the NN can define the likelihoods to be included in the rulesets.

In operation, new data 556 (new evidence) is provided to the reflexive model 564 that has been populated using the NN trained using the gradient-based approximation 562. The reflexive model 564 includes domain knowledge 558 provided by the operator 330 that indicates rules that are to be completed by the NN. The reflexive model 564 operates on the new data 556 to make an inference 568 and an explanation 570 of why the inference 568 was made.

FIG. 6 illustrates, by way of example, a diagram of an embodiment of an NN 334 that operates to determine whether a penguin is present based on provided evidence. The NN 334 includes an input layer 660 into which features indicating evidence likelihoods are provided. The evidence, in the example of FIG. 6, is “is large bird”, “is black and white”, “drinks saltwater”, and “can fly”. Each example evidence in FIG. 6 is positively indicative of a penguin being present. The input layer 660 operates on the evidence and provides an output to hidden layers 662. The hidden layers 662 operate to provide an output to an explainability layer 664. The explainability layer 664 indicates the likelihoods that are used to complete the rules. The explainability layer 664 operates to provide output to an output layer 666. The explainability layer 664 can be initialized with weights that are zero. Because the weights can be positive (meaning the evidence, when present, is a positive indicator of the consequent) or negative (meaning the evidence, when present, is a negative indicator of the consequent), zero is neutral. This means that the neuron is not biased towards evidence being a positive or negative indicator. For the explanatory variables to capture explanations that are semantically linked to terms of the input vector (as in FIG. 6), the shape of the learned parameters to the right of 662 (connected to the box for differentiable phi 668) must be the same as the shape as the input evidence vectors 660.

The output layer 666 operates to determine the consequent. In the example of FIG. 6, the consequent is an object classification indicating whether or not a penguin is present based on the provided evidence.

The consequent can be determined using the reflexive model function 668 Equations:

$${φ}_{p} = ( a + b ) ( 1 - c ) [ - a ( ε + τ - 2 ) + ε - 1 ] + τ - ε$$

$$H ( x ) = \{ \begin{matrix}1 , & x > 0 \\ 0 , & x \leq 0\end{matrix}$$

$$a = H ( τ - ε )$$

$$b = H ( ε - τ )$$

$$c = H ( ( 1 - ε ) τ ( 1 - τ ) ε )$$

φₚ represents φₚₑᵣₘᵢₛₛᵢᵥₑ.

The hidden layers 662 of the NN 334 operate to determine τ and ε and the corresponding a, b, and c that depend on τ and ε. The output layer 666 operates to determine φₚ. To “relax” φₚ the Heaviside function

$$H ( x ) = \{ \begin{matrix}1 , & x > 0 \\ 0 , & x \leq 0\end{matrix}$$

can be replaced with a differentiable approximation φₚₑᵣₘᵢₛₛᵢᵥₑƒ(x, t)\hat{ } where x is the input described in the equations above and t is a tuning parameter; other approximations may use multiple additional parameters. An example differentiable approximation is

$$f ( x , t ) \approx {lim}_{t \to ∞} ( tanh ( xt ) + 1 ) / 2.$$

Other approximations can be used, such as logistic curves, or any other ‘S-shaped’ curve which in some limit approaches the Heaviside step function. The parameters of the differentiable approximation may themselves be tuned over the course of training on an independent scheduler, such as by using cosine annealing, or other scheduling functions common in the art. Thus in one embodiment, the example function ƒ(x, t) may have a low value for t at the start of training, and a high value of t towards the end of training. The rate of change of the parameter t may be controlled by a scheduler, for example, using cosine annealing. The relaxed function φ^{˜} differs from the original function φ* in that it uses an approximation of the Heaviside function, thus providing for differentiability, and in the fact that it is treated a set of functions, where the parameters (t) to the annealing function ƒ vary over the course of training a machine learning model which can approximate the inference performed by φ*.

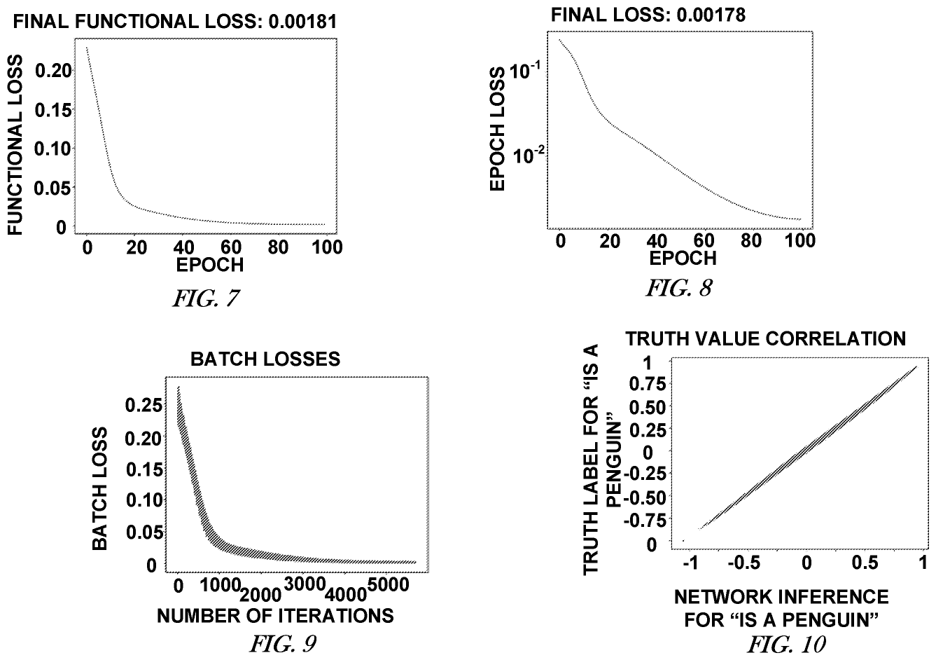

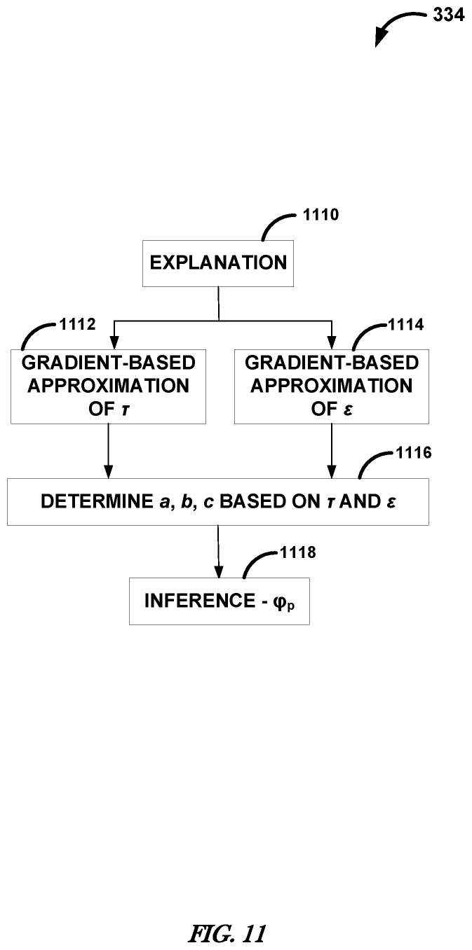

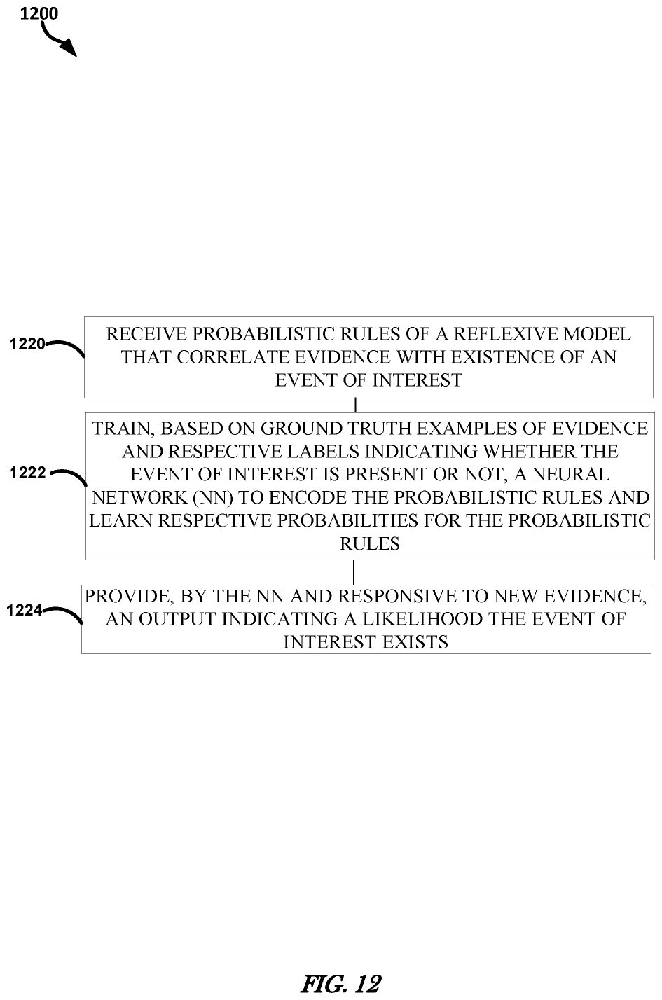

FIGS. 7, 8, 9, and 10 illustrate, by way of example, respective graphs of a variety of results for training and operation of an instance of a system that implements the technique 300. FIG. 7 illustrates a functional loss per epoch. As can be seen the final functional loss is quite low indicating that the annealing approach to estimating the reflexive model function is very accurate. FIG. 8 illustrates an epoch loss per epoch. Like the functional loss, the epoch loss is quite small. FIG. 9 illustrates batch loss per number of iterations. Like the epoch loss and the functional loss, the batch loss is quite small. FIG. 10 illustrates a truth value correlation between a truth label and the inference made by the reflexive model with probabilities filled in by an NN.

For the system that implements the technique 300 the following ground truth rules and NN derived rules of tables 1 and 2 were realized. As can be seen, the network derived rules are close to ground truth.

TABLE 1
Ground truth, manually determined likelihoods based on evidence.

| Rule | Likelihood | Positive or Negative Indicator |
|---|---|---|
| Has Tapered Body | 0.1 | 1 |
| Drinks Saltwater | 0.5 | 1 |
| Is Large Bird | 0.8 | 1 |
| Is Black and White | 0.3 | 1 |
| Can Fly | 1.0 | −1 |

TABLE 2
Network determined likelihoods based
on same evidence as Table 1.

| Rule | Likelihood | Positive or Negative Indicator |
|---|---|---|
| Has Tapered Body | 0.128595 | 1 |
| Drinks Saltwater | 0.51654 | 1 |
| Is Large Bird | 0.79454 | 1 |
| Is Black and White | 0.31778 | 1 |
| Can Fly | 1.05042 | −1 |

FIG. 11 illustrates a conceptual diagram of an embodiment of an NN 334 to implement the technique 300. The NN 334 includes layers 1110, 1112, 1114, 1116, 1118 configured to perform operations of the reflexive model 564 including inference 568 and explanations 570. The explanation layer 1110 indicates the evidence that is most impactful to the inference, such as in an order from highest impact to lowest impact. The gradient-based approximation layers 1112, 1114 are configured to determine τ and ε. The layers 116 are configured to determine a, b, and c based on the approximated τ and ε. The inference layers 1118 are configured to determine the classification and corresponding confidence. The inference layers 1118, in other words, are configured to determine a value for φₚ that is based on a, b, c, τ and ε. The layers 1110, 1112, 1114, 1116, 1118 can include accumulation, sgn, addition, multiplication, subtraction, other layers, or the like. The layers 1110, 1112, 1114, 1116, 1118 can rely on prior results (feed backward) or only new results (feed forward) or a combination thereof.

A difference between embodiments and prior work is similar to the difference between building/using a static decision tree (which is just if-then rules and how to combine them) and learning the tree from data (AI). The reflexive model (which are weighted modal rules) and its inference process (how to combine those rules) is one thing; learning the reflexive model from data is a different process (AI).

The reflexive model is a hybrid probabilistic logical model that does not require priors, can handle uncertainty, can handle both positive and negative predictors, and can handle missing evidence. Specifically, it leverages a type-2 probability system over possible worlds where each world is a probabilistically assigned collection of modal logic statements. Operators specify weighted rules that are encoded as strict conditionals, and the model provides inference and accompanying metrics for sets of weighted evidence (i.e. new data) in light of those rules; the inference describes the probability that the target variable can be inferred along a spectrum from false to true over the set of possible worlds; the metrics describe the probabilities of unique logical states such as certain truth of the target variable, certain falsehood of the target variable, ambiguity given the evidence, and inconsistency given the evidence. The inferences can be explained directly in terms of those rules, as can the model as a whole.

FIG. 12 illustrates, by way of example, a diagram of an embodiment of a method 1200 for learned reflexive model inference and explanation. The method 1200 as illustrated includes receiving probabilistic rules of a reflexive model that correlate evidence with existence of an event of interest, at operation 1220; training, based on ground truth examples of evidence and respective labels indicating whether the event of interest is present or not, a neural network (NN) to encode the probabilistic rules and learn respective probabilities for the probabilistic rules, at operation 1222; and providing, by the NN and responsive to new evidence, an output indicating a likelihood the event of interest exists, at operation 1224. The new evidence is data that is received after deployment of the NN. The new evidence can include signal intelligence, human intelligence, sensor data, content of communications, images, a combination thereof or the like.

The operation 1222 can include using an annealing function to approximate a Heaviside function of the reflexive model. The probabilistic rules can be provided by a subject matter expert of the event of interest. The method 1200 can further include providing, by the NN, an explanation of why a value of the likelihood the event of interest is that value. The explanation can include the probabilistic rules that have a most impact on the value. The NN can include an input layer, hidden layers, and an output layer, wherein the hidden layers include an explanation layer that encodes the probabilities associated with the probabilistic rules. The explanation layer further encodes parameters of a reflexive model equation. The method 1200 can further include altering, based on a communication from an operator, an object in a geographical region of the event of interest.

In traditional probability regimes, one can use some probabilities to derive other probabilities. However, the information needed to derive the other probabilities is not always available. Consider the following problem statement: “On any given day, I make a decision about whether to cook breakfast, b. That decision depends on some measurable independent events: (i) If I am hungry, h, then I cook breakfast; (ii) I will not cook breakfast, b, unless I have time, t; (iii) When I am hungry, h, the probability that I cook breakfast is proportional to what is in the fridge, ƒ; (iv) I do not track my meals or ingredients, so I have no prior knowledge of P(b), P(b∩x), or P(x|b) for any x in h, t, ƒ.”

If one were to interpret this problem statement using a Bayesian paradigm, one will find that information is missing to determine a probability of cooking breakfast. That is P(b|x)=P(x|b)P(b)/(P(b) and P(b)=P(b|x)P(x)/P(x|b) are not fully determinable based on the information provided.

If one were to interpret this problem statement as P(b)=P(h)P(t)P(ƒ), essential information regarding two distinct states is missing. Not having time, t, and not being hungry, h, is correctly computed because there is no conflict there. However, not having time, t, and being hungry, h, will result in the inference of not cooking breakfast, but that is not necessarily the case. There is still some probability that being hungry, h, will cause breakfast to be cooked even with limited or insufficient time, t.

The conflict realized, using a type-1 probability regime, of being hungry, h, and not having time, t, can be seen pretty clearly using propositional logic:

TABLE 4
Propositional Logic Contradiction Flow

| | | |
|---|---|---|
| 1 | h → b | Premise |
| 2 | ¬t → ¬b | Premise |
| 3 | h | Event |
| 4 | ¬t | Event |
| 5 | ¬h ∨ b | DeMorgan's law (1) |
| 6 | t ∨ ¬b | DeMorgan's law, double negation (2) |
| 7 | b | Disjunctive Syllogism (3), (5) |
| 8 | ¬b | Disjunctive Syllogism (4), (6) |
| 9 | b Λ ¬b | Conjunction (7, 8) - Contradiction |

One way to help solve this issue is to assign a probability to a predicate. For example, assume that P(ƒ)=50%. It is imagined that there are two possible evenly weighted outcomes, in one, I eat breakfast, b, and in the other, I do not eat breakfast, b. In the following example, assume the following simplified statements hold: “On any given day, I make a decision about whether to cook breakfast, b. That decision depends on a measurable independent event: (i) When I am hungry, h, the probability that I cook breakfast is proportional to what is in the fridge, ƒ”

Table 5 shows how a type-2 probability system helps solve this issue.

TABLE 5
Type-2 Probability System Interpretation of
probability-assigned predicate example.

| | | | | | |
|---|---|---|---|---|---|
| 1 | f → b | Premise | 1 | f → b | Premise |
| 2 | ¬f → ¬b | Premise | 2 | ¬f → ¬b | Premise |
| 3 | f | Event | 3 | ¬f | Event |
| 4 | b | Hypothetical | 4 | ¬b | Hypothetical |
| | | Syllogism (1, 3) | | | Syllogism (2, 3) |

| | |
|---|---|
| World 1 | World 2 |

In a next example, consider that P(ƒ) is based on a combination of ingredients in the fridge. For every ingredient in the fridge, the probability of eating breakfast, P(ƒ), increases. Consider the following problem statement: “On any given day, I make a decision about whether to cook breakfast, b. That decision depends on measurable independent events: (i) If I have eggs, e, I am 50% likely to eat breakfast, b, P(e→b)=0.5; (ii) I am 50% likely to have eggs, e, P(e)=0.5.

TABLE 6
Type-2 Probability System Interpretation of problem
wherein both rules and evidence are probabilistically
instantiated (single rule, non-modal logic).

| 1 | e → b | Premise | 1 | ¬(e → b) | Premise |
|---|---|---|---|---|---|
| 2 | e | Event | 2 | e | Event |
| 3 | b | Hypothetical | 3 | ¬(¬e ∨ b) | Conditional |
| | | Syllogism | | | Disjunction |
| | | (1, 3) | | | (1) |
| | Type equation here. | | 4 | e ∧ ¬b | DeMorgan |
| | | | | | (3) |
| | | | 5 | ¬b | Conjunction |
| | | | | | (4) |
| World 1 | | | World 2 | | |
| 1 | e > b | Premise | 1 | ¬(e → b) | Premise |
| 2 | ¬e | Event | 2 | ¬e | Event |
| 3 | ¬e ∨ b | Conditional | 3 | ¬(¬e ∨ b) | Conditional |
| | | Disjunction | | | Disjunction |
| | | (1), b is | | | (1) |
| | | ambiguous | | | |
| | Type equation here. | | 4 | e ∧ ¬b | DeMorgan |
| | | | | | (3) |
| | | | 5 | e ∧ ¬e | Conjunction |
| | | | | | (2, 4), |
| | | | | | contradiction |

| | |
|---|---|
| World 3 | World 4 |

Problem 1: This gives rise to inconsistent worlds where positive and negative evidence are combined. In states where b is true, the ability to include negative evidence, such as not having time, or not having ingredients without contradiction, is lost. In states where b is false, the ability to include positive evidence such as hunger, or having other ingredients without contradiction is lost.

Problem 2: If one ignores ambiguity and contradiction, the probabilities from the problem statement are no longer satisfied because that means “I always have eggs” and problem 1 is still realized.

Problem 3: If one includes ambiguity and contradiction in the probability mass, problem 1 is realized, and there is a less useful quantification of b, namely:
25% chance of b
25% chance of not b
25% chance of contradiction
25% chance of ambiguity

Consider another example, with another ingredient. Assume the problem statement: On any given day, I make a decision about whether to cook breakfast, b. That decision depends on some measurable independent events: If I have eggs, e, I am 50% likely to eat breakfast, P(e→b)=0.5; If I have yogurt, y, I am 50% likely to eat breakfast, P(y→b)=0.5; For simplicity, let's say P(e)=P(y)=1. Under this problem statement, one knows that they are 75% likely to eat breakfast, but this system of inference cannot draw that conclusion.

TABLE 7
Type-2 Probability System Interpretation of problem
wherein both rules and evidence are probabilistically
instantiated (two rules, non-modal logic).

| 1 | e → b | Premise | 1 | ¬(e → b) | Premise |
|---|---|---|---|---|---|
| 2 | y → b | Event | 2 | y → b | Event |
| 3 | e ∧ y | Event | 3 | e ∧ y | Event |
| 4 | b | Hypothetical | 4 | b | Hypothetical |
| | | Syllogism | | | Syllogism |
| | | (1, 3) | | | (2, 3) |
| | | | 5 | ¬(¬e ∨ b) | Conditional |
| | | | | | Disjunction (1) |
| | | | 6 | e ∧ ¬b | DeMorgan (5) |
| | | | 7 | b ∧ ¬b | Conjunction |
| | | | | | (4, 6), |
| | | | | | Contradiction |
| World 1 | | | World 2 | | |
| 1 | e → b | Premise | 1 | ¬(e → b) | Premise |
| 2 | ¬(y → b) | Event | 2 | ¬(y → b) | Event |
| 3 | e ∧ y | Event | 3 | e ∧ y | Event |
| 4 | b | Hypothetical | 4 | ¬(¬e → b) | Conditional |
| | | Syllogism (1,3) | | | Disjunction (1) |
| 5 | ¬(¬y ∨ b) | Conditional | 5 | ¬(¬y ∨ b) | Conditional |
| | | Disjunction (2) | | | Disjunction (2) |
| 6 | y ∧ ¬b | DeMorgan (5) | 6 | e ∧ ¬b | DeMorgan (4) |
| 7 | b ∧ ¬b | Conjunction (4, | 7 | y ∧ b | DeMorgan (5) |
| | | 6), Contradiction | | | |
| | | | 8 | ¬b | Conjunction (7) |

| | |
|---|---|
| World 3 | World 4 |

Using modal logic, the problem of combining ingredients can be solved. This is shown using propositional modal logic as shown in Table 8. The problem statement for this example is the same as that associated with Table 7. Modal logic helps solve the problem because, for example, ¬(e→b) is interpreted as “I have eggs and I do not eat breakfast”, whereas the modal logic statement ¬□(e→b) is interpreted as “I cannot prove anything definitive about breakfast using the truth value of e”. The end state of ambiguity denotes a state in which neither truth hood or falsity of the event of interest (b) can be validly inferred by the rules of the system. Table 8 summarizes four worlds using modal logic and type-2 probability.

TABLE 8
Type-2 Probability System Interpretation of problem
wherein both rules and evidence are probabilistically
instantiated (two rules, modal logic).

| 1 | □(e → b) | Premise | 1 | ¬□(e → b) | Premise |
|---|---|---|---|---|---|
| 2 | □(y → b) | Event | 2 | □(y → b) | Event |
| 3 | e ∧ y | Event | 3 | e ∧ y | Event |
| 4 | b | Strict | 4 | b | Strict |
| | | Conditional | | | Conditional |
| | | (1, 3) | | | (2, 3) |
| World 1 | | | World 2 | | |
| 1 | □(e → b) | Premise | 1 | □(e → b) | Premise |
| 2 | ¬□(y → b) | Event | 2 | ¬□(y → b) | Event |
| 3 | e ∧ y | Event | 3 | e ∧ y | Event |
| 4 | b | Strict | 4 | | Ambiguity |
| | | Conditional | | | |
| | | (1, 3) | | | |

| | |
|---|---|
| World 3 | World 4 |

Using modal logic satisfies the problem statements and comports with expectations. Modal logic also supports negative evidence against the event of interest and missing evidence.

AI is a field concerned with developing decision-making systems to perform cognitive tasks that have traditionally required a living actor, such as a person. NNs are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The model 220 (sometimes referred to as the NN 334, AI model 444, or reflexive model 564), or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph-if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

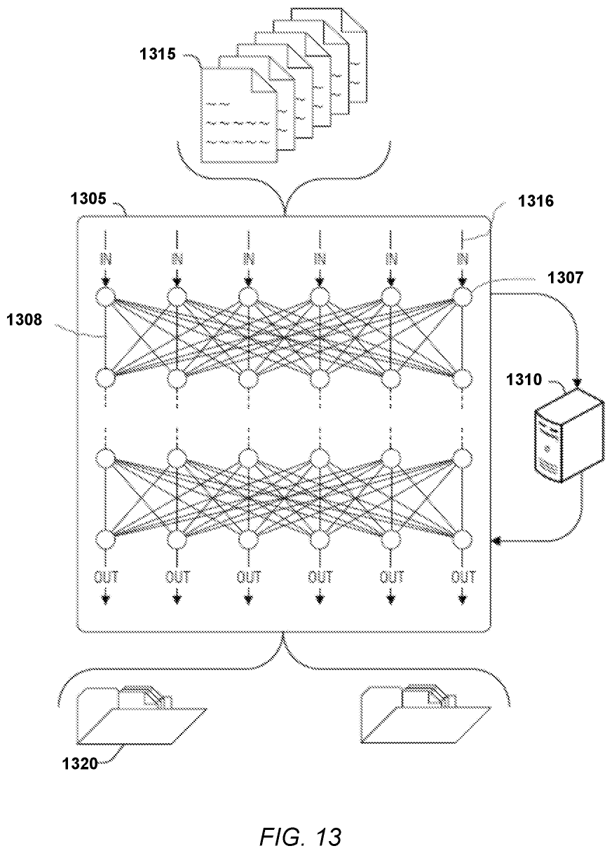

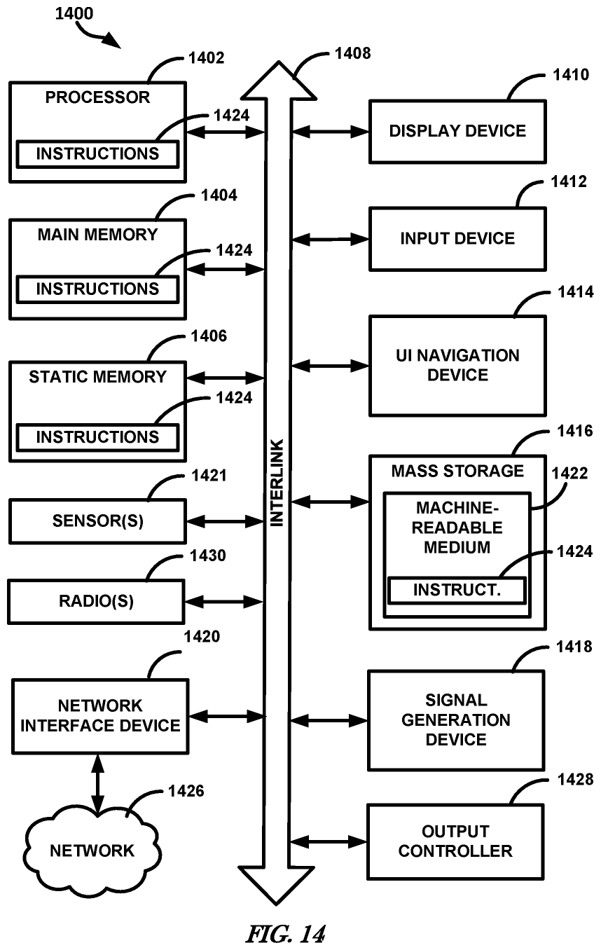

FIG. 13 is a block diagram of an example of an environment including a system for neural network (NN) training. The system includes an artificial NN (ANN) 1305 that is trained using a processing node 1310. The processing node 1310 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 1305, or even different nodes 1307 within layers. Thus, a set of processing nodes 1310 is arranged to perform the training of the ANN 1305. The model 220 (sometimes referred to as the NN 334, AI model 444, or reflexive model 564), or the like, can be trained using the system.

The set of processing nodes 1310 is arranged to receive a training set 1315 for the ANN 1305. The ANN 1305 comprises a set of nodes 1307 arranged in layers (illustrated as rows of nodes 1307) and a set of inter-node weights 1308 (e.g., parameters) between nodes in the set of nodes. In an example, the training set 1315 is a subset of a complete training set. Here, the subset may enable processing nodes with limited storage resources to participate in training the ANN 1305.

The training data may include multiple numerical values representative of a domain, such as an image feature, or the like. Each value of the training or input 1315 to be classified after ANN 1305 is trained, is provided to a corresponding node 1307 in the first layer or input layer of ANN 1305. The values propagate through the layers and are changed by the objective function.

As noted, the set of processing nodes is arranged to train the neural network to create a trained neural network. After the ANN is trained, data input into the ANN will produce valid classifications 1320 (e.g., the input data 1315 will be assigned into categories), for example. The training performed by the set of processing nodes 1307 is iterative. In an example, each iteration of the training the ANN 1305 is performed independently between layers of the ANN 1305. Thus, two distinct layers may be processed in parallel by different members of the set of processing nodes. In an example, different layers of the ANN 1305 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 1307 (e.g., neurons) are trained independently. In an example, the nodes are trained on different hardware.

FIG. 14 illustrates, by way of example, a block diagram of an embodiment of a machine in the example form of a computer system 1400 within which instructions, for causing the machine to perform any one or more of the methods or techniques discussed herein, may be executed. One or more of the input collection 102, model construction 104, inference 106, sensing system 116, model 220, operations of the techniques 300, 400, 500, the NN 334, AI model 444, reflexive model 564, method 1200, system of FIG. 13, or other component, operation, or technique, can include, or be implemented or performed by one or more of the components of the computer system 1400. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard), a user interface (UI) navigation device 1414 (e.g., a mouse), a mass storage unit 1416, a signal generation device 1418 (e.g., a speaker), a network interface device 1420, and a radio 1430 such as Bluetooth, WWAN, WLAN, and NFC, permitting the application of security controls on such protocols.

The mass storage unit 1416 includes a machine-readable medium 1422 on which is stored one or more sets of instructions and data structures (e.g., software) 1424 embodying or utilized by any one or more of the methodologies or functions described herein. The instructions 1424 may also reside, completely or at least partially, within the main memory 1404 and/or within the processor 1402 during execution thereof by the computer system 1400, the main memory 1404 and the processor 1402 also constituting machine-readable media.

While the machine-readable medium 1422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 1424 may further be transmitted or received over a communications network 1426 using a transmission medium. The instructions 1424 may be transmitted using the network interface device 1420 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### ADDITIONAL EXAMPLES

Example 1 includes a method for reflexive model generation and inference, the method comprising receiving probabilistic rules of a reflexive model that correlate evidence with existence of an event of interest, training, based on ground truth examples of evidence and respective labels indicating whether the event of interest is present or not, a neural network (NN) to encode the probabilistic rules and learn respective probabilities for the probabilistic rules, and providing, by the NN and responsive to new evidence, an output indicating a likelihood the event of interest exists.

In Example 2, Example 1 further includes, wherein training the NN includes using an annealing function to approximate a Heaviside function of the reflexive model.

In Example 3, at least one of Examples 1-2 further includes, wherein the probabilistic rules are provided by a subject matter expert of the event of interest.

In Example 4, at least one of Examples 1-3 further includes providing, by the NN, an explanation of why a value of the likelihood the event of interest is that value.

In Example 5, Example 4 further includes, wherein the explanation includes the probabilistic rules that have a most impact on the value.

In Example 6, at least one of Examples 1-5 further includes, wherein the NN includes an input layer, hidden layers, and an output layer, wherein the hidden layers include an explanation layer that encodes the probabilities associated with the probabilistic rules.

In Example 7, Example 6 further includes, wherein the explanation layer further encodes parameters of a reflexive model equation.

In Example 8, at least one of Examples 1-7 further includes altering, based on a communication from an operator, an object in a geographical region of the event of interest.

Example 9 includes a non-transitory machine-readable medium including instructions that, when executed by a machine, cause the machine to perform operations for reflexive model generation and inference, the operations comprising receiving probabilistic rules of a reflexive model that correlate evidence with existence of an event of interest, training, based on ground truth examples of evidence and respective labels indicating whether the event of interest is present or not, a neural network (NN) to encode the probabilistic rules and learn respective probabilities for the probabilistic rules, and providing, by the NN and responsive to new evidence, an output indicating a likelihood the event of interest exists.

In Example 10, Example 9 further includes, wherein training the NN includes using an annealing function to approximate a Heaviside function of the reflexive model.

In Example 11, at least one of Examples 9-10 further includes, wherein the probabilistic rules are provided by a subject matter expert of the event of interest.

In Example 12, at least one of Examples 9-11, wherein the operations further comprise providing, by the NN, an explanation of why a value of the likelihood the event of interest is that value.

In Example 13, Example 12 further includes, wherein the explanation includes the probabilistic rules that have a most impact on the value.

In Example 14, at least one of Examples 9-13 further includes, wherein the NN includes an input layer, hidden layers, and an output layer, wherein the hidden layers include an explanation layer that encodes the probabilities associated with the probabilistic rules.

In Example 15, Example 14 further includes, wherein the explanation layer further encodes parameters of a reflexive model equation.

Example 16 includes a system comprising processing circuitry, a display, a memory coupled to the processing circuitry and the display, the memory including instructions that, when executed by the processing circuitry, cause the processing circuitry to perform operations for reflexive model generation and inference, the operations comprising receiving probabilistic rules of a reflexive model that correlate evidence with existence of an event of interest, training, based on ground truth examples of evidence and respective labels indicating whether the event of interest is present or not, a neural network (NN) to encode the probabilistic rules and learn respective probabilities for the probabilistic rules, and providing, by the NN and responsive to new evidence, an output indicating a likelihood the event of interest exists.

In Example 17, Example 16 further includes, wherein training the NN includes using an annealing function to approximate a Heaviside function of the reflexive model.

In Example 18, at least one of Examples 16-17 further includes, wherein the probabilistic rules are provided by a subject matter expert of the event of interest.

In Example 19, at least one of Examples 16-18 further includes, wherein the operations further comprise providing, by the NN, an explanation of why a value of the likelihood the event of interest is that value.

In Example 20, Example 19 further includes, wherein the explanation includes the probabilistic rules that have a most impact on the value.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for reflexive model generation and inference, the method comprising:
receiving probabilistic rules of a reflexive model that correlate evidence with existence of an event of interest;
training, based on ground truth examples of evidence and respective labels indicating whether the event of interest is, was, or will be present or not, a neural network (NN) to encode the probabilistic rules and learn respective probabilities for the probabilistic rules; and
providing, by the NN and responsive to new evidence, an output indicating a likelihood the event of interest exists.

2. The method of claim 1, wherein training the NN includes using an annealing function to approximate a Heaviside function of the reflexive model.

3. The method of claim 1, wherein the probabilistic rules are provided by a subject matter expert of the event of interest.

4. The method of claim 1, further comprising providing, by the NN, an explanation of why a value of the likelihood the event of interest is that value.

5. The method of claim 4, wherein the explanation includes the probabilistic rules that have a most impact on the value.

6. The method of claim 1, wherein the NN includes an input layer, hidden layers, and an output layer, wherein the hidden layers include an explanation layer that encodes the probabilities associated with the probabilistic rules.

7. The method of claim 6, wherein the explanation layer further encodes parameters of a reflexive model equation.

8. The method of claim 1, further comprising altering, based on a communication from an operator, an object in a geographical region of the event of interest.

9. A non-transitory machine-readable medium including instructions that, when executed by a machine, cause the machine to perform operations for reflexive model generation and inference, the operations comprising:
receiving probabilistic rules of a reflexive model that correlate evidence with existence of an event of interest;
training, based on ground truth examples of evidence and respective labels indicating whether the event of interest is, was, or will be present or not, a neural network (NN) to encode the probabilistic rules and learn respective probabilities for the probabilistic rules; and
providing, by the NN and responsive to new evidence, an output indicating a likelihood the event of interest exists.

10. The non-transitory machine-readable medium of claim 9, wherein training the NN includes using an annealing function to approximate a Heaviside function of the reflexive model.

11. The non-transitory machine-readable medium of claim 9, wherein the probabilistic rules are provided by a subject matter expert of the event of interest.

12. The non-transitory machine-readable medium of claim 9, wherein the operations further comprise providing, by the NN, an explanation of why a value of the likelihood the event of interest is that value.

13. The non-transitory machine-readable medium of claim 12, wherein the explanation includes the probabilistic rules that have a most impact on the value.

14. The non-transitory machine-readable medium of claim 9, wherein the NN includes an input layer, hidden layers, and an output layer, wherein the hidden layers include an explanation layer that encodes the probabilities associated with the probabilistic rules.

15. The non-transitory machine-readable medium of claim 14, wherein the explanation layer further encodes parameters of a reflexive model equation.

16. A system comprising:
processing circuitry;
a display;
a memory coupled to the processing circuitry and the display, the memory including instructions that, when executed by the processing circuitry, cause the processing circuitry to perform operations for reflexive model generation and inference, the operations comprising:
receiving probabilistic rules of a reflexive model that correlate evidence with existence of an event of interest;
training, based on ground truth examples of evidence and respective labels indicating whether the event of interest is, was, or will be present or not, a neural network (NN) to encode the probabilistic rules and learn respective probabilities for the probabilistic rules; and
providing, by the NN and responsive to new evidence, an output indicating a likelihood the event of interest exists.

17. The system of claim 16, wherein training the NN includes using an annealing function to approximate a Heaviside function of the reflexive model.

18. The system of claim 16, wherein the probabilistic rules are provided by a subject matter expert of the event of interest.

19. The system of claim 16, wherein the operations further comprise providing, by the NN, an explanation of why a value of the likelihood the event of interest is that value.

20. The system of claim 19, wherein the explanation includes the probabilistic rules that have a most impact on the value.
